(19) United States
(12) Patent Application Publication
(10) Pub. No.: US 2006/0179466 A1
(43) Pub. Date: Aug. 10, 2006

(54) System and method of providing email service via a set top box

(75) Inventors: Larry B. Pearson, San Antonio, TX (US); Matthew Strand Bruening, San Antonio, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/051,553

(22) Filed: Feb. 4, 2005

(51) Int. Cl. H04N 7/173

(52) U.S. Cl. 725/109; 725/110

(57) ABSTRACT

A method of providing email services via a set top box is described and includes periodically polling an email messaging server from the set top box over a data network. The method further includes identifying a user account that has received one or more emails and communicating an indication to a user having the user account that the one or more emails have been received. The indication is communicated at a display coupled to the set top box during one or more television commercials. Particularly, the indication can be communicated between the fifty eighth and sixtieth minute of each hour. Moreover, the indication can be communicated between the twenty eighth and thirtieth minute of each hour. The indication can also be communicated between the thirteenth and fifteenth minute of each hour. Further, the indication can be communicated between the forty third and forty fifth minute of each hour.

### FIELD OF THE DISCLOSURE

The present disclosure relates to set top boxes.

### BACKGROUND

For years, televisions have been a staple of consumer electronics sales. As such, a large majority of households in the United States owns at least one television. Providing content to those televisions is a lucrative business. However, it is a saturated business with much competition. As such, many content providers have tried to “piggy back” other non-television services with television services in order to gain a competitive advantage. Some content providers, in particular, have tried to add computer services, such as email services, but these services can be difficult to implement. For example, responding to emails received via a set top box can be difficult—especially, when attempting to respond using a typical remote control device as an interface. Moreover, managing emails sent to multiple users via a single set top box can also be difficult.

Accordingly, there is a need for an improved system and method of providing email service via a set top box.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of an entertainment system;

FIG. 2 is a general diagram representative of an embodiment of a graphical user interface that can be used to set up email services provided by the set top box;

FIG. 3 is a general diagram representative of an embodiment of a graphical user interface that can be used to edit one or more user settings;

FIG. 4 is a general diagram representative of a first embodiment of a graphical user interface that can be used to input one or more messaging configuration details;

FIG. 5 and FIG. 6 are general diagrams representative of a second embodiment of a graphical user interface that can be used to input one or more messaging configuration details;

FIG. 7 is a general diagram representative of an embodiment of a graphical user interface that can be used to input one or more messaging notification options;

FIG. 8 is a general diagram representative of an embodiment of a television view showing a pop-up message notification;

FIG. 9 is a general diagram representative of an embodiment of a television view showing a select user graphical user interface;

FIG. 10 is a general diagram representative of an embodiment of a television view showing a personal identification number entry graphical user interface;

FIG. 11 is a general diagram representative of an embodiment of a television view showing a messaging inbox graphical user interface;

FIG. 12 is a general diagram representative of an embodiment of a television view showing a messaging view graphical user interface;

FIG. 13 is a general diagram representative of an embodiment of a television view showing a messaging reply graphical user interface;

FIG. 14 is a general diagram representative of an embodiment of a television view showing a messaging personal address book graphical user interface; and

FIG. 15 is a flow chart to illustrate a second portion of a method of providing email services via a set top box.

### DETAILED DESCRIPTION OF THE DRAWINGS

A method of providing email services via a set top box is described and includes periodically polling an email messaging server from the set top box over a data network. The method further includes identifying a user account that has received one or more emails and communicating an indication to a user having the user account that the one or more emails have been received. The indication is communicated at a display coupled to the set top box during one or more television commercials.

In a particular embodiment, the indication can be communicated between the fifty eighth and sixtieth minute of each hour. Moreover, the indication can be communicated between the twenty eighth and thirtieth minute of each hour. The indication can also be communicated between the thirteenth and fifteenth minute of each hour. Further, the indication can be communicated between the forty third and forty fifth minute of each hour. In a particular embodiment, the indication can be a visual indication or an audio indication. Additionally, a distinct audio indication is transmitted for each of a plurality of users of the set top box.

In another embodiment, a method of providing email services via a set top box is described. The method includes receiving an email message at the set top box and providing an indication that the email message has been received. Further, the method includes receiving a recorded response to the email message from a user and transmitting the recorded response to the email messaging server.

In yet another embodiment, a set top box is described and includes a processor and a computer readable medium that is accessible by the processor. A computer program is embedded within the computer readable medium. The computer program includes instructions to periodically poll an email messaging server and instructions to flag each user account that has received an email message. Additionally, the computer program includes instructions to display a messaging inbox graphical user interface (GUI). The messaging inbox GUI includes one or more received email messages. Further, the messaging inbox GUI is displayed during one or more television commercials.

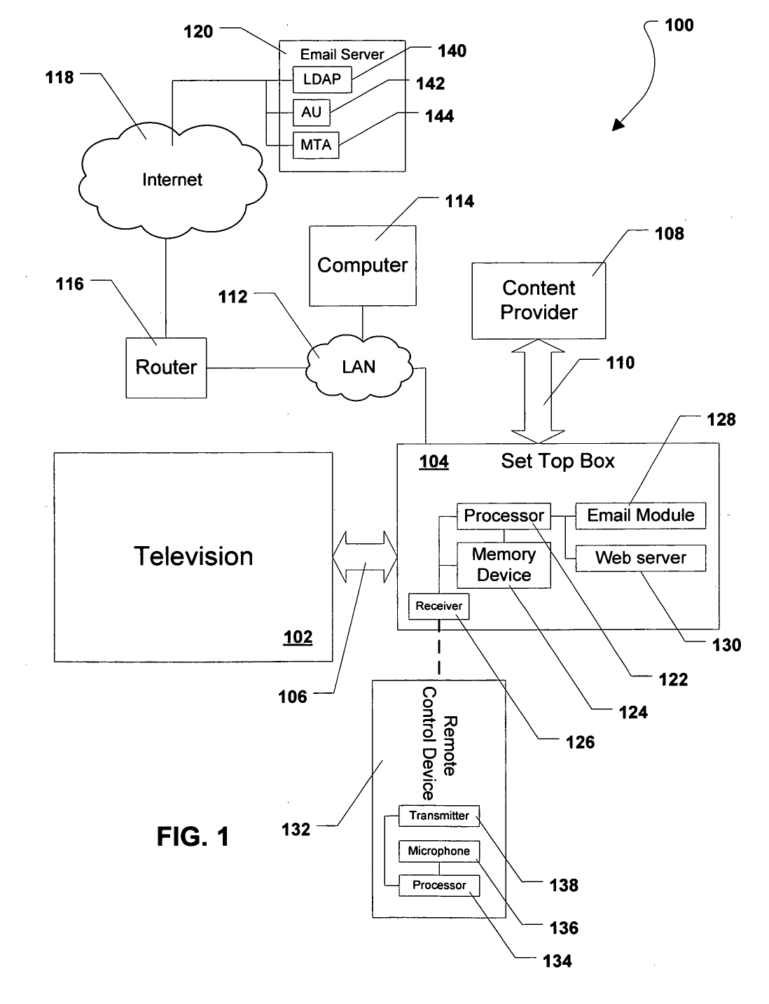

Referring to FIG. 1, a system is illustrated and is generally designated 100. As illustrated in FIG. 1, in an exemplary, non-limiting embodiment, the system 100 includes a television 102, but it can be appreciated that the system 100 can include any display device on which video content can be displayed. FIG. 1 indicates that a set top box 104 can be connected to the television 102 via a first broadband connection 106. The set top box 104 is also connected to a content provider 108, e.g., a cable company or a digital satellite company, via a second broadband connection 110. As shown, the set top box 104 can also be coupled to a local area network (LAN) 112. The LAN 112 can connect the set top box 104 to a computer 114 and to a router 116. The router 116 can further provide connectivity to the Internet 118. In turn, the Internet 118 can connect the set top box 104 to an email messaging server 120. In an exemplary embodiment, the router 116 servers as a router, a firewall, and a network address translator (NAT) device.

FIG. 1 indicates that the set top box 104 includes a processor 122 in which logic, such as user interface logic, can be executed. Further, the set top box 104 includes a memory device 124 in which content from the content provider can be downloaded and stored. FIG. 1 also shows that the set top box 104 can include a receiver 126, e.g., an IR/RF receiver, that is configured to receive one or more IR/RF signals from a remote control device. In a particular embodiment, the memory device 124 is a computer readable medium such as a hard drive, a random access memory (RAM), a flash drive, or any other type of memory device. FIG. 1 also shows that the set top box 104 can include an email module 128 and a web server 130 that are coupled to the processor 122.

FIG. 1 also depicts a remote control device 132 that can communicate with the set top box 104 to allow user interaction with the system 100 during operation. The remote control device 132 can communicate with the set top box 104 via one or more infrared (IR) signals, radio frequency (RF) signals, or other wireless signals. As depicted in FIG. 1, the remote control device 132 can include a processor 134 to which a microphone 136 and a transmitter 138 can be coupled.

As shown in FIG. 1, the email messaging server 120 can include a lightweight directory access protocol (LDAP) server 140 that can provide directory or address book services to authorized users of the set top box 104. Moreover, the email messaging server 120 includes an access unit (AU) 142 that can be used to retrieve email messages from the email messaging server 120. For example, email messages can be retrieved using post office protocol (POP3) or Internet mail access protocol (IMAP4). The email messaging server 120 can also include a message transfer agent (MTA) 144 that can be used to deposit email messages on the email messaging server 120 or forward email messages to other mail servers connected to the Internet. Simple mail transfer protocol (SMTP) can be used to transmit messages between the set top box 104 and the email messaging server 120.

In a particular embodiment, during operation, the email module 128 within the set top box 104 can poll the email messaging server 120 to determine if any authorized users of the set top box 104 have any email messages. If so, the email messages can be delivered to the set top box 104 and the user can be notified that an email message has been received. In an illustrative embodiment, the user can respond to an email message by recording a voice message using the microphone 136 that is embedded in the remote control device 132. Then, the recorded voice message can be communicated to the set top box 104 via the transmitter 138. The recorded voice message can be sent by the set top box 104 to the email messaging server 120 as a response to the email message. In a particular embodiment, the computer 114 can access the set top box 104 via the web server 130 embedded within the set top box 104 to provide an alternate interface to the set top box 104.

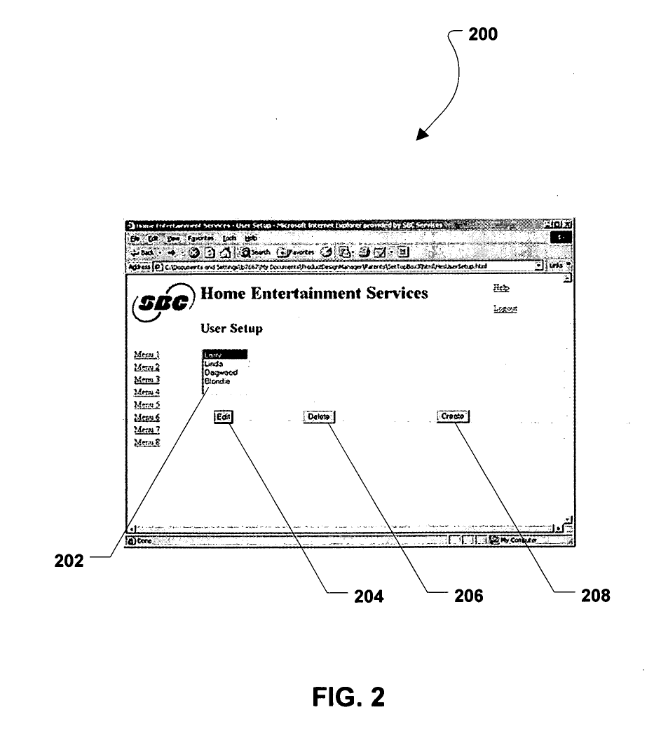

FIG. 2 depicts an exemplary, non-limiting embodiment of a graphical user interface (GUI), generally designated 200. As shown the GUI 200 is a user setup GUI that can be presented to a user at the television 102 (FIG. 1) during the configuration of the email services that can be provided via the set top box 104 (FIG. 1). As shown in FIG. 2, in one embodiment, the user setup GUI 200 includes a user name list 202, an edit soft button 204, a delete soft button 206, and a create soft button 208. An existing user can select his or her name from the user name list 202 and select the edit soft button 204 in order to edit one or more user settings. The delete soft button 206 can be selected in order to delete a user from the user name list. Further, the create soft button 208 can be selected to create a new user account.

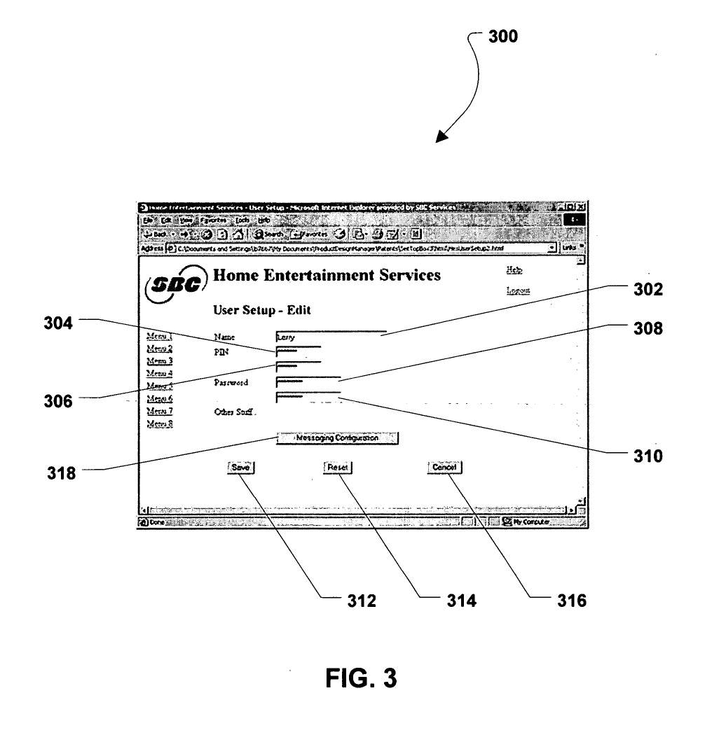

FIG. 3 illustrates an exemplary, non-limiting embodiment of an edit GUI, generally designated 300, that can be presented to a user at the television 102 (FIG. 1) when the edit soft button 204 (FIG. 2) is selected at the user setup GUI 200 (FIG. 2). As shown, the edit GUI 300 includes a name input field 302, a first PIN input field 304, a second PIN input field 306, a first password input field 308, and a second password input field 310. Additionally, the edit GUI 300 includes a save soft button 312, a reset soft button 314, and a cancel soft button 316. When the save soft button 312 is selected, the user settings entered in the input fields 302,304, 306,308,310 are saved. When the reset soft button 314 is selected, the input fields 302,304,306,308, 310 are reset. Further, when the cancel soft button 316 is selected the user setup is cancelled. FIG. 3 also depicts a messaging configuration soft button 318.

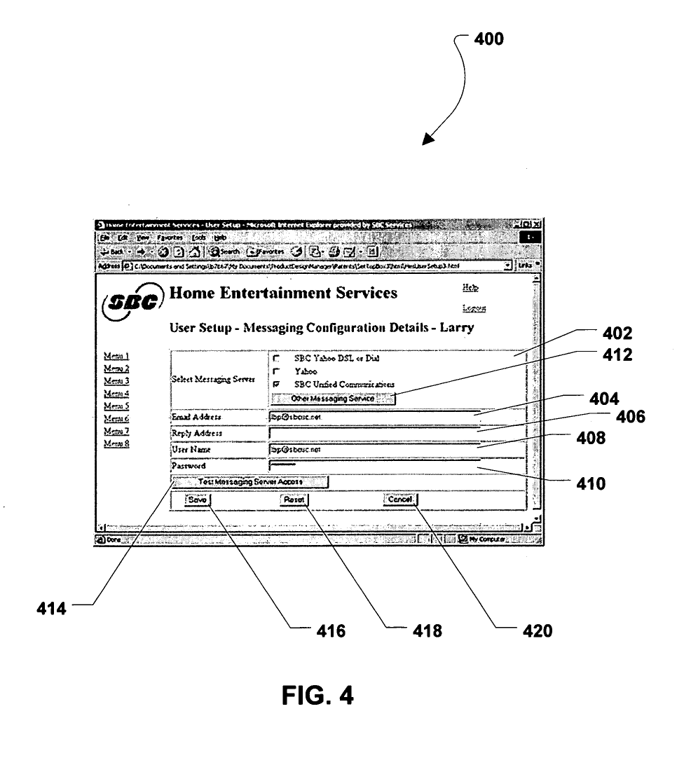

FIG. 4 depicts an exemplary, non-limiting embodiment of a first messaging configuration GUI, generally designated 400, that can be presented to a user when the messaging configuration soft button 318 (FIG. 3) is selected at the edit GUI 300 (FIG. 3). As shown in FIG. 4, the messaging configuration GUI 400 includes a messaging server selection window 402, an email address input field 404, a reply address input field 406, a user name input field 408, and a password input field 410. A user can select the messaging server that he or she uses for email services from the options presented at the messaging server selection window 402. Then, the user can input his or her email address to the email address input field 404. A user name associated with the email account can be input to the user name input field 408. Further, a password for the email account can be input to the password input field 410.

FIG. 4 further illustrates an other messaging service soft button 412, a test messaging server access soft button 414, a save soft button 416, a reset soft button 418, and a cancel soft button 420. When the test messaging server access soft button 414 is selected, the set top box tests the messaging server interfaces input by the user. When the save soft button 416 is selected, the user email messaging settings are saved. When the reset soft button 418 is selected, the input fields 404, 406, 408, 410 are reset. Further, when the cancel soft button 420 is selected the messaging configuration is cancelled. Additionally, when the other messaging service soft button 412 is selected a second messaging service configuration GUI can be presented to the user.

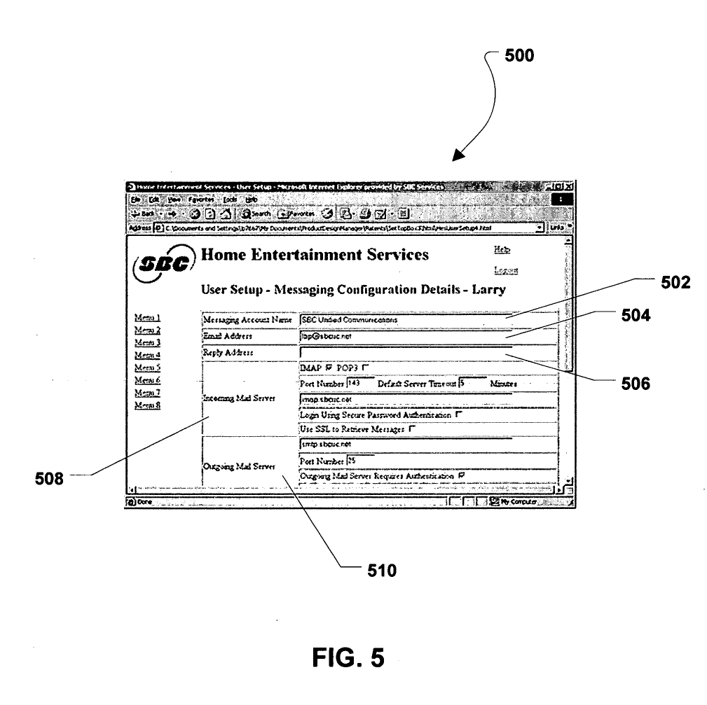

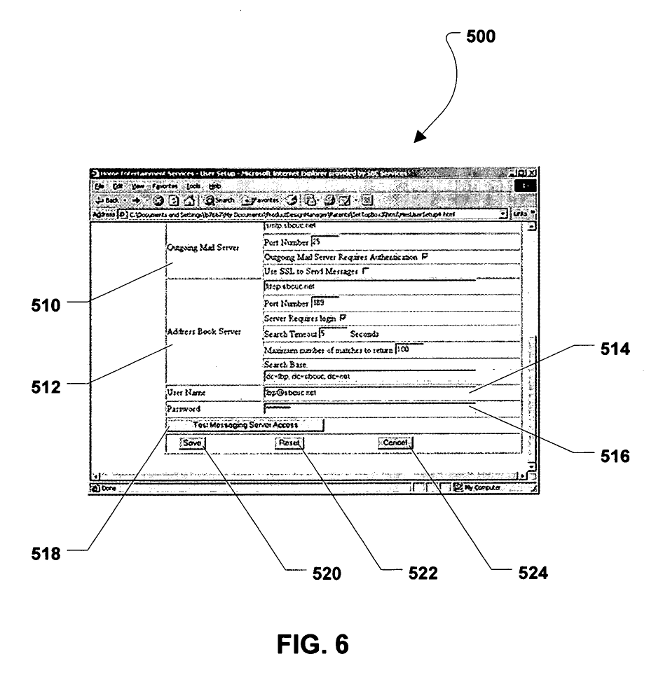

In a particular embodiment, the set top box can include one or more mail server configuration presets or templates that can be used to support a number of different mail servers. For example, when a user selects a particular messaging server from the select messaging server window 402, shown in FIG. 4, such as SBC Yahoo DSL or dial, the configuration details, shown in FIG. 5 and FIG. 6 that are manually input for other messaging services, may be automatically set without input from the user. Thus, the user can save time during set up of his or her email messaging services.

FIG. 5 and FIG. 6 show an exemplary, non-limiting embodiment of a second messaging configuration GUI, generally designated 500, that can be presented to a user when the other messaging service soft button 412 (FIG. 4) is selected at the first messaging service configuration GUI 400 (FIG. 4). In a particular embodiment, the GUI 500 shown in FIG. 6 appears when a user scrolls down from the GUI 500 shown in FIG. 5. As illustrated, the second messaging configuration GUI 500 includes a messaging account name input field 502 to which the user's messaging account name can be entered. Further, the second messaging configuration GUI 500 includes an email address input field 504 and a reply address input field 506. The user can input his or her email address to the email address input field 504 and a reply address to the reply address input field 506.

As depicted in FIG. 5, the second messaging configuration GUI 500 can include an incoming mail server information window 508 and an outgoing mail server information window 510. In a particular embodiment, the user can input information related to the incoming mail server via the incoming mail server information window 508. That information can include the URL of the incoming mail server, a port number, a default server timeout indication, whether to login using secure password authorization, whether to use IMAP4 of POP3 for email access, and whether to use SSL to retrieve email messages. Also, in a particular embodiment, the user can input information related to the outgoing mail server via the outgoing mail server information window 510. That information can include the URL of the outgoing mail server, a port number, whether the outgoing mail server requires authorization, and whether to use SSL to send email messages.

FIG. 6 shows that the second messaging configuration GUI 500 can also include an address book server information window 512. In a particular embodiment, the user can input information related to an address book server via the address book server information window 512. That information can include a URL of the address book server, a port number, whether the server requires a login, a search timeout selection, a maximum number of matches to return, and a search base. FIG. 6 shows that the second messaging configuration GUI 500 also includes a-user name input field 514 and a password input field 516. Additionally, the second messaging configuration GUI 500 can include a test messaging server access soft button 518, a save soft button 520, a reset soft button 522, and a cancel soft button 524.

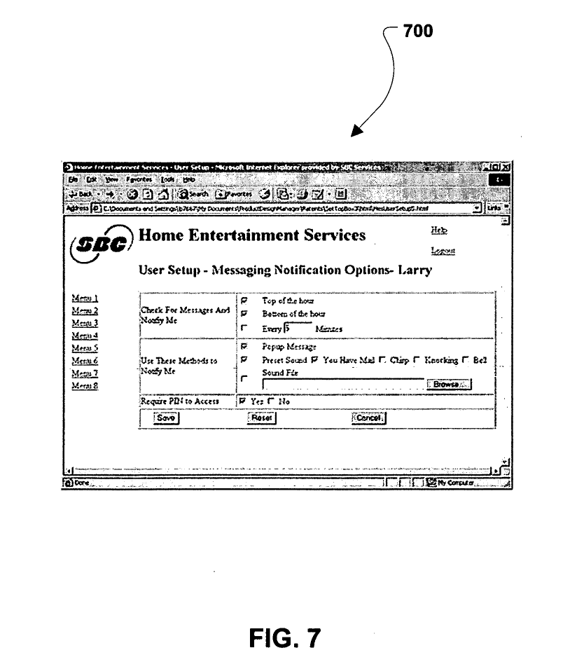

Referring now to FIG. 7, a messaging notification options GUI is shown and is generally designated 700. Using the messaging notification options GUI 700, a user can have his or her email messages delivered at the top of the hour, at the bottom of the hour, or every X number of minutes, e.g., every 5 minutes. Further, the user can select how the system will notify the user that email has been received. For example, a user can choose to be notified by a popup message or a user selected sound. Also, the user can indicate whether or not a PIN will be required to access his or her email messages.

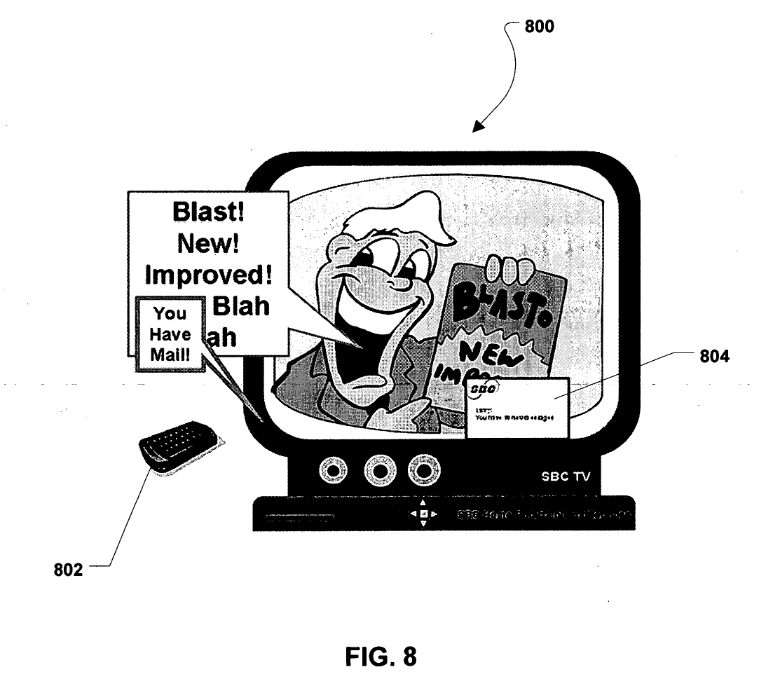

FIG. 8 shows a television, generally designated 800, and a remote control device 802. While a user is watching the television 800, a popup notification 804 can be presented when email has arrived or during a predetermined alert window, e.g., the top of the hour or bottom of the hour, when the broadcast content is more likely to be a commercial. Also, an audible notification can be sounded. In a particular embodiment, the set top box can provide a distinct audio alert for each authorized user of the set top box.

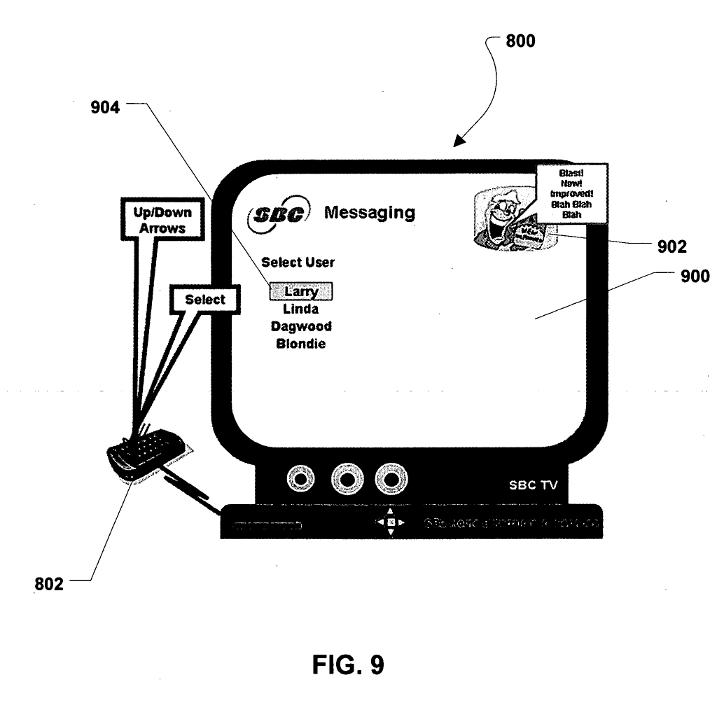

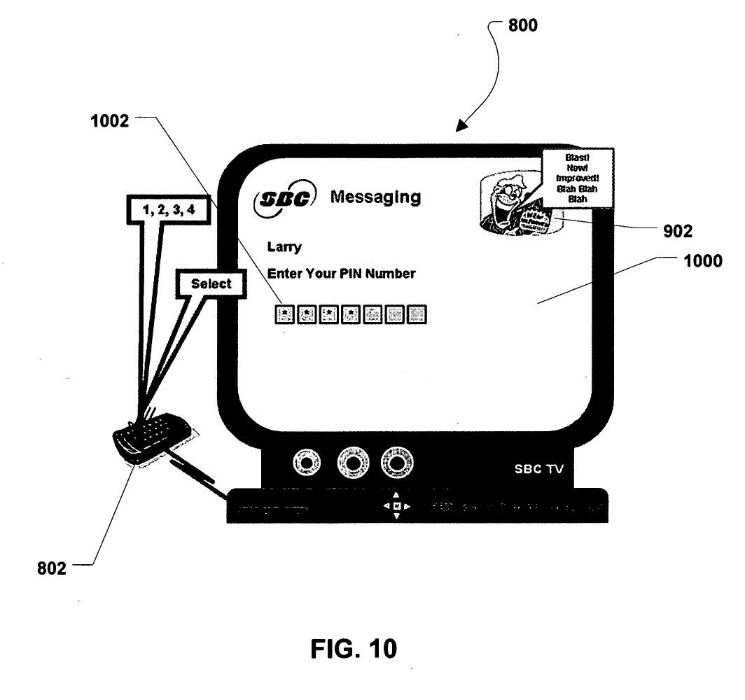

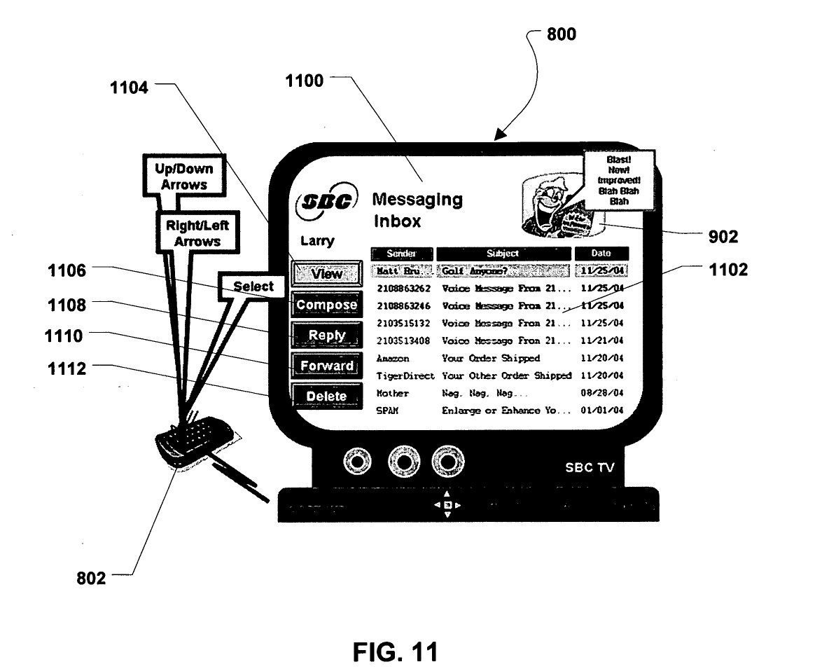

FIG. 9 shows that when the user selects check email using the remote control device 802 a messaging interface 900 can be presented at the television. The broadcast content can appear in picture-in-picture window 902. As such, a user will know when the commercials have ended and toggle back to the broadcast content. FIG. 9 shows that the messaging interface 900 can include a user list 904. When a user's name is selected at the user list 904, a PIN entry interface 1000, shown in FIG. 10, can be presented to the user. The PIN entry interface 1000 includes a PIN input field 1002 and when a correct PIN is received, a messaging inbox interface 1100, shown in FIG. 11, can be presented at the television 800.

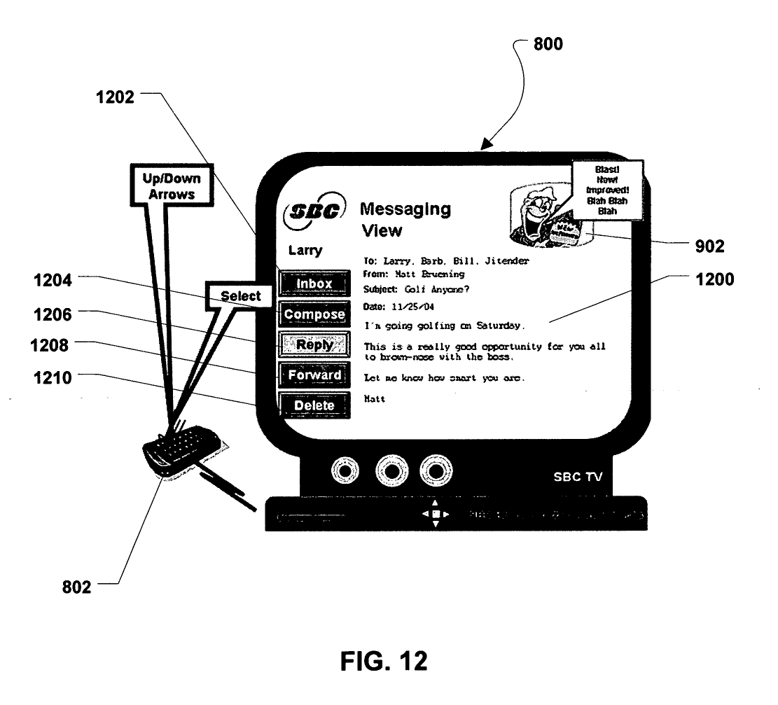

As shown in FIG. 11, the messaging inbox interface 1100 can include an email list 1102. In a particular embodiment, the email list 1102 can include a sender, a subject, and a date for each email message received. Further, the messaging inbox interface 1100 can include a view soft button 11 04, a compose soft button 1106, a reply soft button 1108, a forward soft button 1110, and a delete soft button 1112. A user can navigate between the soft buttons 1104, 1106, 1108, 1110, 1112 using the remote control device 802. When the view soft button 1104 is selected, a messaging view interface 1200, depicted in FIG. 12, can be presented to the user at the television 800.

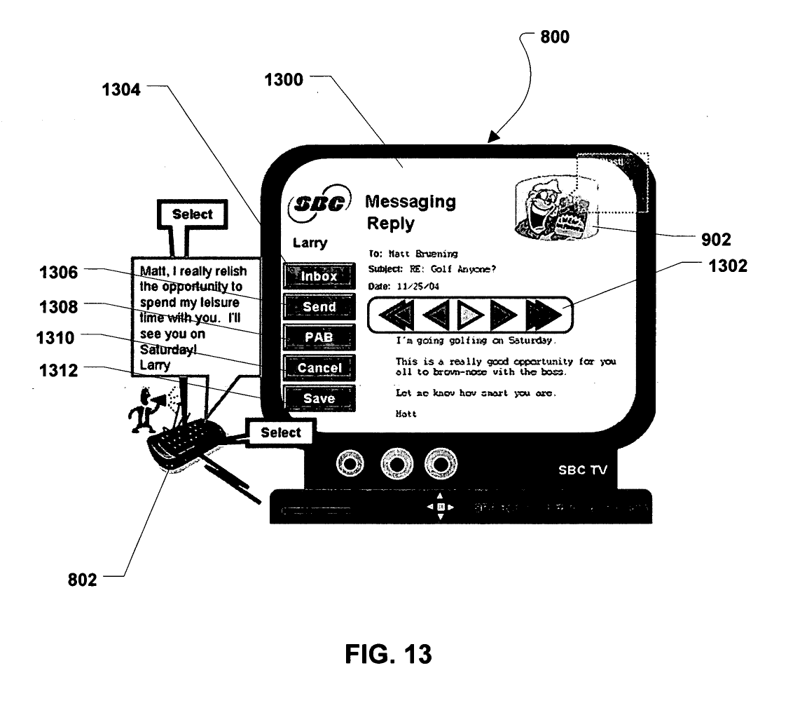

FIG. 12 illustrates that the messaging view interface 1200 can include the contents of a selected email message. Further, the messaging view interface 1200 can include an inbox soft button 1202, a compose soft button 1204, a reply soft button 1206, a forward soft button 1208, and a delete soft button 1210. A user can navigate between the soft buttons 1202, 1204, 1206, 1208, 1210 using the remote control device 802. When the reply soft button 1206 is selected, a messaging reply interface 1300, depicted in FIG. 13, can be presented to the user at the television 800.

As depicted in FIG. 13, the messaging reply interface 1300 can include an audio control interface 1302. Additionally, the messaging reply interface 1300 can include an inbox soft button 1304, a send soft button 1306, a personal address book (PAB) soft button 1308, a cancel soft button 1310, and a save soft button 1312. A user can navigate between the soft buttons 1304, 1306, 1308, 1310, 1312 using the remote control device 802. When the messaging reply interface 1300 is selected, a user can record a response to the email message using the remote control device 802.

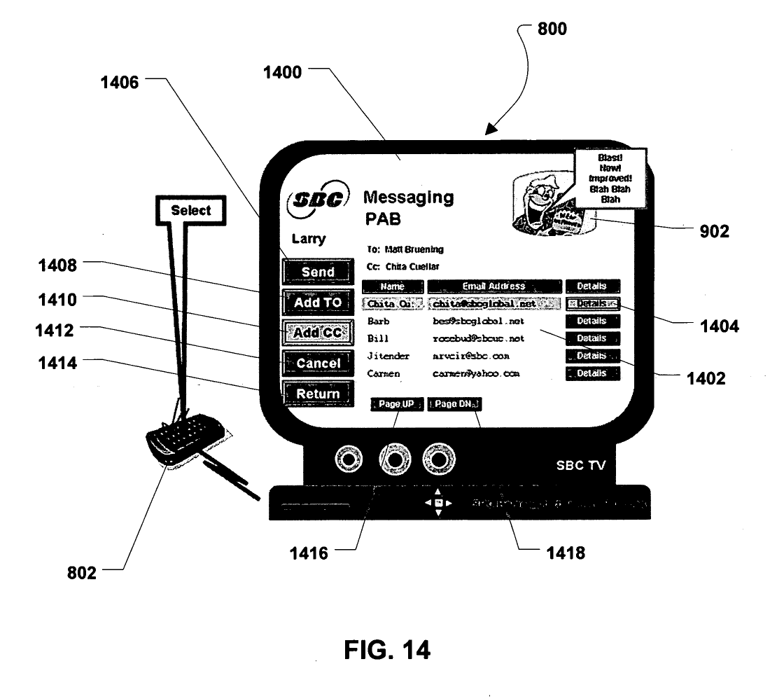

FIG. 14 shows a messaging PAB interface 1400 that can be displayed when the PAB soft button 1308 is selected at the messaging reply interface 1300 (FIG. 13). As shown, the messaging PAB interface 1400 can include an email address list 1402. Each entry on the email address list 1402 can include a name, an email address, and a details soft button 1404 that can be selected to view further details about the entry on the email address list 1402. FIG. 14 further indicates that the messaging PAB interface 1400 can include a send soft button 1406, an add to soft button 1408, an add carbon copy (CC) soft button 1410, a cancel soft button 1412, and a return soft button 1414. Also, the messaging PAB 1400 can include a page up soft button 1416 and a page down soft button 1418. In an illustrative embodiment, the PAB is not stored at the set top box, but it is stored at an email messaging server and transmitted to the set top box when requested by a user.

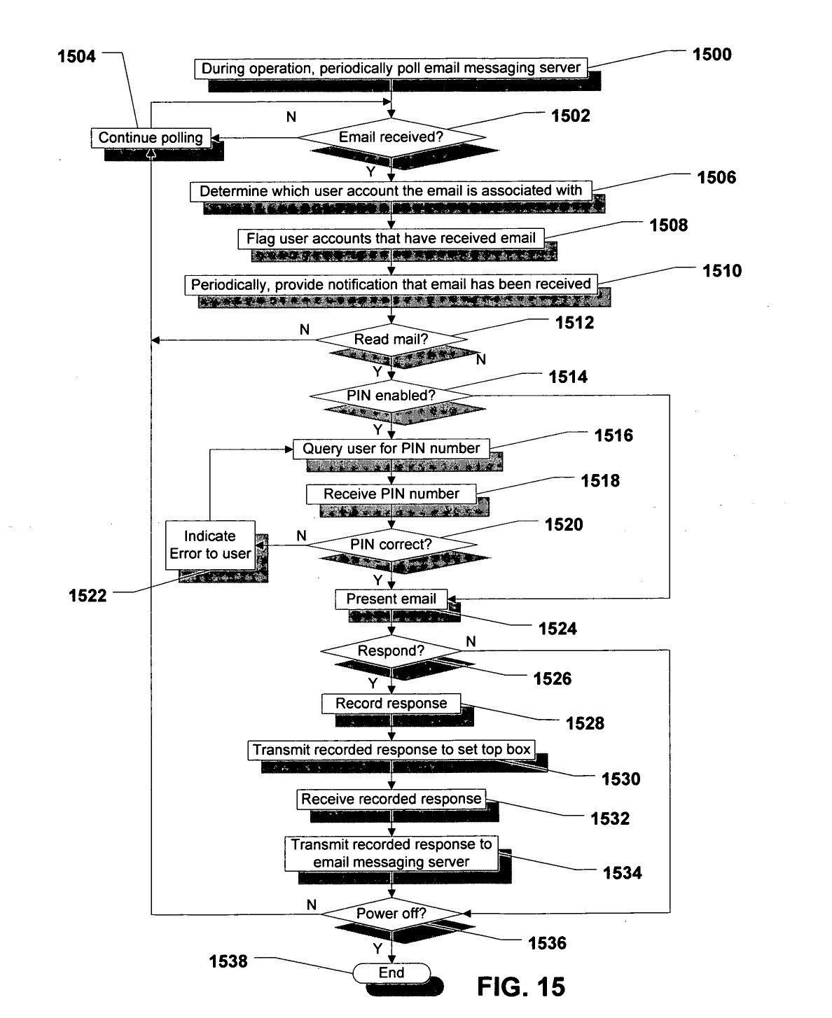

Referring to FIG. 15, a method of providing email service via a set top box is shown and commences at block 1500. At block 1500, during operation, the set top box, e.g., an email module within the set top box, periodically polls an email messaging server. At decision step 1502, the set top box determines whether any emails have been received at the email messaging server. If not, the method moves to block 1504 and the set top box continues to periodically poll the email messaging server. The method then returns to decision step 1502 and continues as described.

At decision step 1502, if an email message is received, the set top box determines a user account that the email is associated with at block 1506. Moving to block 1508, the set top box flags user accounts that have received email. At block 15 10, the set top box periodically provides notification that email has been received. In a particular embodiment, the set top box can notify users at the top of every hour, at the bottom of every hour, or during any other predefined portion of each hour. Further, in a particular embodiment, the set top box can poll the email messaging server within the same window of time that it notifies the user of incoming mails. Alternatively, the polling process performed by the set top box can be de-coupled from the notification process and the set top box can poll the email messaging server at random times during each hour prior to notifying the user.

Moreover, in a particular embodiment, the set top box can notify users between the fifty eighth and sixtieth minute of each hour, between the twenty eighth and thirtieth minute of each hour, between the thirteenth and fifteenth minute of each hour, and between the forty third and forty fifth minute of each hour. Depending on the timing of the commercials, each of these email message notification windows can be shifted up or down a few minutes. Further, each email message notification window can be expanded by a few minutes to ensure that notifications occur during commercials. Further, the set top box can notify the user by interrupting the sound from the television and replacing the television audio with an audio notification message, such as “You have mail.” Additionally, a pop up window can slide up from the bottom of the TV screen and overlay a portion of the broadcast content. The pop up window can remain stationary for a predetermined time period, e.g., thirty seconds or less, and then, slide back down and disappear.

Continuing to decision step 1512, the set top box determines whether a user has selected to read his or her email messages. If no such selection has been made, the method returns to block 1504 and the set top box continues to periodically poll the email messaging server. If the user has indicated that he or she would like to read the email messages, the method proceeds to decision step 1514 and the set top box determines whether PIN access is enabled for the user. If so, the set top box queries the user for his or her PIN, e.g., by presenting the PIN entry interface shown in FIG. 10, at block 1516. At block 1518, the PIN is received. Proceeding to block 1520, the set top box determines whether the PIN is correct. If not, the method moves to block 1522 and the set top box indicates an error to the user. Thereafter, the method returns to block 1516 and the set top box queries the user for the PIN again. The logic then continues as described above.

At decision step 1520, if the PIN is correct, the method continues to block 1524 and the set top box presents the email message to the user, e.g., by displaying the messaging inbox interface shown in FIG. 11. Returning to decision step 1514, if PIN access is not enabled, the method skips the PIN entry steps and moves directly to block 1524 where the email message is presented to the user. While the messaging inbox interface is displayed, the sound level for the program in the picture-in-picture window can be lowered or muted completely.

From block 1524, the method continues to decision step 1526 and the set top box determines whether a user has indicated that he or she would like to respond to the email message. If the user elects to respond, the method proceeds to block 1528 and the remote control device records a response to the email message using the microphone embedded therein. Thereafter, at block 1530, the remote control device transmits the recorded response to the set top box 1530. At block 1532, the set top box receives the recorded response. Moving to block 1534, the set top box transmits the recorded response to the email messaging server. The recorded response can be transmitted to the email messaging server as an audio file such as an MPEG layer 3 (MP3) file or any other type of audio file. The method then moves to decision step 1536.

Returning to decision step 1526, if the user has not indicated that he or she would like to respond to the email message, the method proceeds to decision step 1536. At decision step 1536, the set top box determines whether the power to the set top box has been turned off. If the power is not turned off, the method returns to block 1504 and the set top box continues to periodically poll the email messaging server. If the power is turned off, the method ends at state 1538.

With the configuration of structure described above, the system and method of providing email service via a set top box provides a way for a user to receive email messages via a set top box and respond to those email messages by recording a voice message using a remote control device. Further, the system and method provides a way to anticipate when commercials are likely being presented via the set top box and notify the user that one or more email messages have been received during the commercial break in order to prevent interruption of the program that the user is watching.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing email services via a set top box, the method comprising:
periodically polling an email messaging server from the set top box over a data network;
identifying a user account that has received one or more emails; and
communicating an indication to a user having the user account that the one or more emails have been received, wherein the indication is communicated at a display coupled to the set top box during one or more television commercials.

2. The method of claim 1, wherein the indication is communicated between the fifty eighth and sixtieth minute of each hour.

3. The method of claim 1, wherein the indication is communicated between the twenty eighth and thirtieth minute of each hour.

4. The method of claim 1, wherein the indication is communicated between the thirteenth and fifteenth minute of each hour.

5. The method of claim 1, wherein the indication is communicated between the forty third and forty fifth minute of each hour.

6. The method of claim 1, wherein the indication is a visual indication.

7. The method of claim 1, wherein the indication is an audio indication.

8. The method of claim 6, wherein a distinct audio indication is transmitted for each of a plurality of users of the set top box.

9. A method of providing email services via a set top box, the method comprising:
receiving an email message at the set top box;
providing an indication that the email message has been received;
receiving a recorded response to the email message from a user; and
transmitting the recorded response to the email messaging server.

10. The method of claim 9, wherein the recorded response is an MP3 audio file.

11. The method of claim 10, wherein the recorded response is received from a remote control device.

12. The method of claim 11, wherein the recorded response is recorded at the remote control device.

13. The method of claim 10, further comprising receiving a request for a personal address book.

14. The method of claim 13, further comprising transmitting the request for the personal address book to an email messaging server.

15. The method of claim 14, further comprising receiving the personal address book from the email messaging server.

16. The method of claim 10, further comprising lowering a volume level at the set top box.

17. The method of claim 16, further comprising displaying a messaging inbox, wherein the messaging inbox comprises one or more email messages including the received email message.

18. A set top box, comprising:
a processor;
a computer readable medium accessible by the processor; and
a computer program embedded within the computer readable medium, the computer program comprising:
instructions to periodically poll an email messaging server;
instructions to flag each user account that has received an email message; and
instructions to display a messaging inbox graphical user interface (GUI), wherein the messaging inbox GUI includes one or more received email messages and wherein the messaging inbox GUI is displayed during one or more television commercials.

19. The device of claim 18, wherein the computer program further comprises instructions to lower a volume level while the messaging inbox GUI is displayed.

20. The device of claim 19, wherein the computer program further comprises instructions to retrieve a personal address book from the email messaging server.

21. The device of claim 20, wherein the personal address book comprises one or more email addresses and a name associated with each of the one or more email addresses.

22. The device of claim 18, wherein the computer program further comprises instructions to display a pop-up window after the email message is received, wherein the pop-up window comprises an indication that the email message has been received.

23. The device of claim 18, wherein the computer program further comprises instructions to display a messaging view GUI after an email message is selected at the messaging inbox GUI.

24. The device of claim 23, wherein the computer program further comprises instructions to display a messaging reply GUI after a reply soft button is selected at the messaging view GUI.

25. The device of claim 24, wherein the computer program further comprises instructions to transmit an audio recorded message to the email messaging server.

26. The device of claim 25, wherein the recorded message is received from a remote control device.
